(19) United States
(12) Patent Application Publication
(10) Pub. No.: US 2009/0047056 A1
(43) Pub. Date: Feb. 19, 2009

(54) ENCAPSULATED FIBER TYPE WRITING INSTRUMENT

(75) Inventor: Morio Akiyama, Kanagawa-ken (JP)

Correspondence Address: GREENBLUM & BERNSTEIN, P.L.C., 1950 ROLAND CLARKE PLACE, RESTON, VA, 20191, US

(73) Assignee: ZEBRA CO., LTD., Tokyo (JP)

(21) Appl. No.: 12/095,359

(22) PCT Filed: Nov. 30, 2005
(86) PCT No.: PCT/JP2005/022017

§ 371 Date: May 29, 2008

(51) Int. Cl. B43K 8/06

(52) U.S. Cl. 401/198

(57) ABSTRACT

The invention provides a writing instrument that can prevent excessive ink from flowing from a writing part integrated with inner fiber and can prevent the writing part from being displaced in a longitudinal direction.

An encapsulated fiber type writing instrument in which the front end side of inner fiber 60 inserted into a stem 40 is protruded from a front end of the stem 40 to use the front end side for a writing part 61 has a characteristic that an annular protrusion 43a that presses an outside face of the inner fiber 60 is provided to an inside face on the front end side of the stem 40.

### BACKGROUND OF THE INVENTION

1. Field of the Invention

The present invention relates to an encapsulated fiber type writing instrument that guides ink with which inner fiber in a stem is impregnated to a writing part, and particularly relates to an encapsulated fiber type writing instrument in which inner fiber and a writing part are integrated.

2. Description of the Related Art

A conventional type encapsulated fiber type writing instrument where inner fiber (a fiber bundle 5) folded in two is inserted into a stem (1) from an opening at its front end, a part left outside the stem (1) of the inner fiber (the fiber bundle 5) is impregnated with a setting agent and after the setting agent is hardened, the part outside the stem (1) of the inner fiber (the fiber bundle 5) is cut to be a writing part (15b) is disclosed in Patent laid-open Sho 61-42099.

In the conventional type encapsulated fiber type writing instrument, as the inner fiber (the fiber bundle 5) is integrated with the writing part (15b), ink that permeates the inner fiber (the fiber bundle 5) can be smoothly supplied to the side of a front end of the writing part (15b), compared with an encapsulated fiber type writing instrument (refer to Patent Document 2) where inner fiber is separate from a writing part.

That is, in a general encapsulated fiber type writing instrument, as in the encapsulated fiber type writing instrument (10) disclosed in Patent Laid-open No. 2003-63190, inner fiber is often separately formed from a writing part, as flow resistance to ink is caused in a location in which the inner fiber and the writing part are touched in such configuration, ink in the inner fiber is not smoothly supplied to the writing part, and failure such as letters are patchy is often caused. In the invention disclosed in Patent Document 1, however, since the inner fiber and the writing instrument are integrated, no flow resistance is caused differently from the above-mentioned case, as a result, a case that letters are patchy is hardly caused, and sufficient ink discharged quantity can be secured.

However, according to the invention disclosed in Patent Document 1, the case that letters are patchy is hardly caused as described above and sufficient ink discharged quantity can be secured, while the encapsulated fiber type writing instrument according to the invention has a problem that since relatively much ink flows in the inner fiber, a phenomenon is easily caused in which excessive ink flows out from an end of the writing part and via clearance between an outside face of the writing part and an inside face of the stem.

In addition, according to the invention, the writing part and the inner fiber that connects with the writing part are sometimes displaced forward or backward because of writing pressure and the impact of a drop.

The invention is made in view of the above-mentioned situation of the conventional types and provides a writing instrument that can prevent excessive ink from flowing out from a writing part integrated with inner fiber and can prevent the writing part from being displaced in a longitudinal direction.

### SUMMARY OF THE INVENTION

To address the problem, a first invention is based upon an encapsulated fiber type writing instrument using the side of a front end of inner fiber inserted into a stem for a writing part by protruding the side of the front end from a front end of the stem. The first invention has a characteristic that an annular protrusion for pressing an outside face of the inner fiber is provided to an inside face on the front end side of the stem, an inner fiber fixing cylinder is formed on the rear side of the annular protrusion of the stem via annular air flowing space, a rear end of the air flowing space is open to the inside of the stem, the air flowing space is extended forward in the stem and its front end is closed, and the air flowing space communicates with a vent extended in a centrifugal direction of the stem on the way on the front end side of the air flowing space.

In addition, a second invention has a characteristic that the inner fiber is impregnated with a setting agent to harden at least the side of the outside face of the inner fiber in the vicinity of the annular protrusion.

In addition, a third invention has a characteristic that the inner fiber is encapsulated in the stem with the inner fiber folded in two.

In addition, a fourth invention has a characteristic that a helical air flowing groove is provided between a pair of helical ribs formed in a range touched to the outside face of the inner fiber on the inside face of the stem and the side of a front end of the air forming groove communicates with the outside of the stem.

Further, a fifth invention has a characteristic that an air flowing groove is provided between a pair of vertical ribs extended in an axial direction of the stem on an inside face on the rear side of the inner fiber fixing cylinder of the stem with the vertical ribs touched to the outside face of the inner fiber and the side of a front end of the air flowing groove communicates with the air flowing space.

As the invention is configured as described above, the following action and effect are produced.

According to the first invention, since the annular protrusion on the inside face of the stem locally presses the side of the outside face of the inner fiber, the distance between fibers on the outside face side of the inner fiber is narrowed and the ink flowing area is also narrowed.

Particularly, the annular protrusion can prevent clearance through which ink flows out from being formed between the inside face on the end side of the stem and the outside face of the inner fiber.

Therefore, an excessive outflow of ink can be prevented.

In addition, as the annular protrusion eats into the outside face of the inner fiber, the writing part formed by the inner fiber can be prevented from being displaced forward or backward because of writing pressure and the impact of a drop.

Further, when the impact of a drop and others are applied to the encapsulated fiber type writing instrument and ink penetrates the air flowing space, the ink can be prevented from flowing out of the vent by hitting the ink on the front end side of the air flowing space.

Further, according to the second invention, as the annular protrusion is fitted to a part hardened by the setting agent on the side of the outside face of the inner fiber, the writing part formed by the inner fiber can be more securely prevented from being displaced forward or backward.

Further, according to the third invention, the inner fiber can be inserted into the stem from the folded part by touching a long jig to the inside of the folded part of the inner fiber folded in two and inserting the jig into the stem in work for inserting the inner fiber into the stem.

Since restoring force that tries to restore the inner fiber to the original condition before folding acts on the inner fiber after insertion, the annular protrusion deeply eats into the outside face of the inner fiber by the restoring force.

Therefore, workability when the inner fiber is inserted is satisfactory and in addition, the writing part formed by the inner fiber can be more securely prevented from being moved forward or backward.

Further, according to the fourth invention, as air can be smoothly taken in the inner fiber according to the consumption of ink by writing owing to the air flowing groove that communicates with the outside and in addition, the air flowing groove is formed helically, space in the air flowing groove can be prevented from being closed by the inner fiber because of the eating of the inner fiber into the air flowing groove even if the inner fiber is rocked in an axial direction of the stem because of the impact of a drop and others.

When the inner fiber is inserted into the stem in the axial direction in manufacturing, the inner fiber can be prevented from eating into the air flowing groove in insertion.

According to the fifth invention, in normal writing, air is taken in from the vent according to the discharge of ink from the writing part, is guided backward through the air flowing space, is guided into the air flowing groove between the pair of vertical ribs, and further, can be guided to the outside face of the inner fiber.

### BRIEF DESCRIPTION OF THE DRAWINGS

FIG. 1 is a sectional view showing one example of an encapsulated fiber type writing instrument according to the invention.

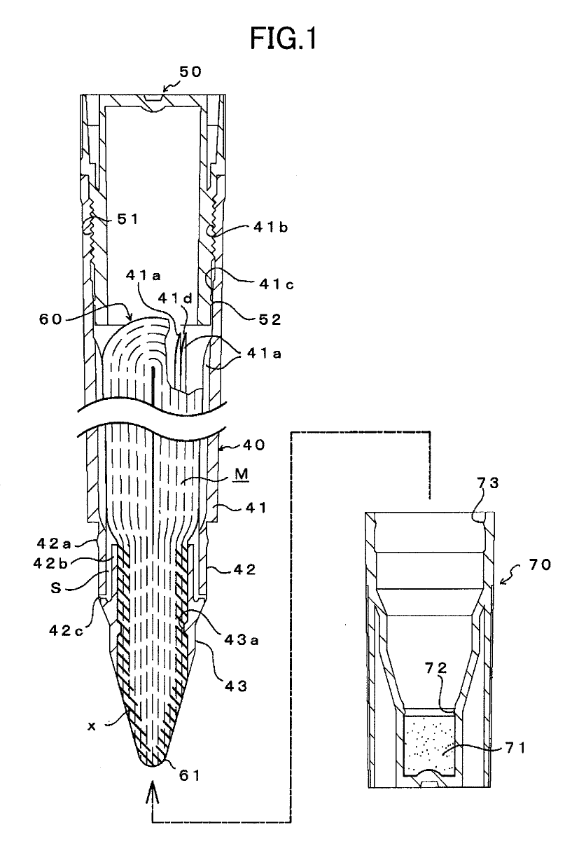

FIG. 2 is an enlarged sectional view showing a main part of the encapsulated fiber type writing instrument.

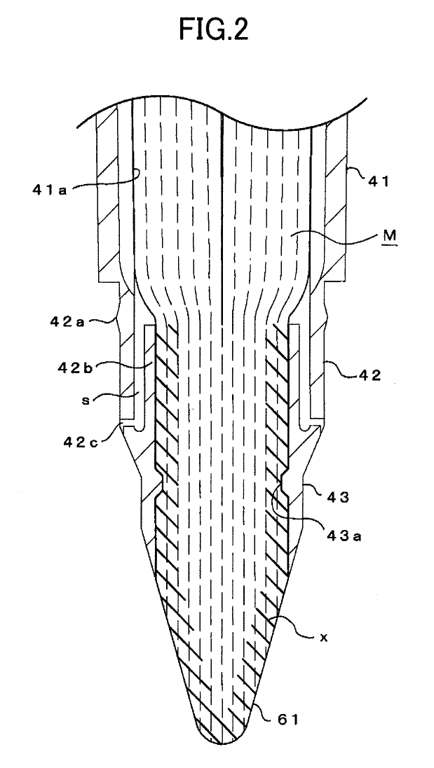

FIG. 3 is Sectional views sequentially ((3A) to (3B)) showing a procedure for assembling the encapsulated fiber type writing instrument.

FIG. 4 is a sectional view showing another example of a stem of the encapsulated fiber type writing instrument according to the invention.

### DESCRIPTION OF THE PREFERRED EMBODIMENTS

Referring to the drawings, an embodiment of the invention will be described below.

An encapsulated fiber type writing instrument is provided with a substantially cylindrical stem 40, inner fiber 60 inserted into the stem 40, a tail cotter 50 installed at a rear end of the stem 40 and a cap 70 detachably installed at a front end of the stem 40, and the side of a front end of the inner fiber 60 is protruded from the front end of the stem 40 to be a writing part 61.

The stem 40 is integrally made of synthetic resin and is provided with a body 41 of the substantially cylindrical stem, a cap fitting part 42 arranged on the side of a front end of the body 41 and a tip 43 arranged further on the side of the front end in front of the cap fitting part 42.

As for the body 41 of the stem, a pair of vertical ribs 41a axially extended with them touched to an outside face of the inner fiber 60 are formed on the side of a front end of its inside face and space between the pair of vertical ribs 41a functions as an air flowing groove 41d.

As the pair of vertical ribs 41a is arranged with one vertical rib 41a close to the other vertical rib 41a, the side of the outside face of the inner fiber 60 is prevented from getting into the air flowing groove 41d between the pair of vertical ribs 41a.

The side of a front end of the air flowing groove 41d between the pair of vertical ribs 41a communicates with air flowing space s described later and air taken from the outside via a vent 42c flows backward in the stem 40.

The plural pairs of vertical ribs 41a are arranged at a predetermined interval in a circumferential direction of the inside face of the stem body 41.

A female screw 41b for mating to a male screw of the tail cotter 50 is formed on the inside face on the rear end side of the stem body 41.

A part on the front side of the female screw 41b of the inside face of the stem body 41 functions as an even press-fitted face 41c for press-fitting an annular projection 51 of the tail cotter 50 to the face fluidtight.

The cap fitting part 42 is provided with an annular projection 42a for fitting the cap 70 over the annular projection 42 on an outside face of the cap fitting part.

An inner fiber fixing cylinder 42b is formed inside the cap fitting part 42 via the annular air flowing space s.

The air flowing space s is extended forward in the stem and communicates with the vent 42c extended in a centrifugal direction of the stem on the way on the side of the front end.

The plural vents 42c are provided at a predetermined interval in a circumferential direction of the stem 40.

According to the above-mentioned configuration, in normal writing, air is taken in via the vent 42c according to the discharge of ink M from the writing part 61, is guided backward through the air flowing space 3, is guided into the air flowing groove 41d between the pair of vertical ribs 41a, and further, can be guided to the outside face of the inner fiber 60.

Therefore, the inner fiber 60 smoothly discharges the ink M, sucking the air taken from the outside.

When the impact of a drop is applied to the encapsulated fiber type writing instrument A and ink M enters the air flowing space s, the ink M is prevented from flowing outside through the vent 42c by making the ink M hit a front end face of the air flowing space s.

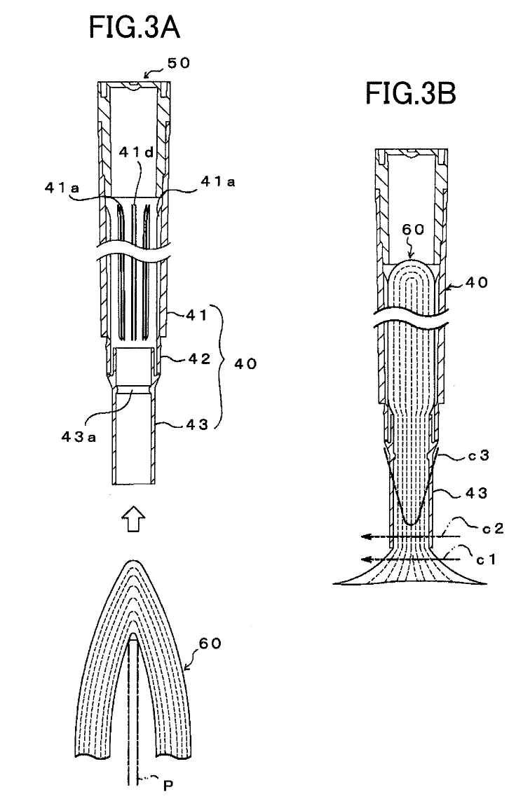

The tip 43 is substantially cylindrically formed so that the tip connects with the inner fiber fixing cylinder 42b. The tip 43 is in the shape of a longer cylinder than the writing part 61 before the writing part 61 is formed as shown in FIG. 3(a).

An annular protrusion 43a is formed on an inside face of the tip 43 and is formed in the substantially same diameter as an inside face of the inner fiber fixing cylinder 42b in a part except the annular protrusion 43a on the inside face of the tip.

The annular protrusion 43a is provided to press the outside face of the inner fiber 60, adequately regulates a flow rate of ink M flowing in the inner fiber 60, and a dimension of its protrusion is suitably set to prevent the inner fiber 60 from being moved in a longitudinal direction.

The inner fiber 60 is made of polyester fiber to be long, as shown in FIG. 3(a), fiber in a state in which the fiber is swollen more than the content volume of the stem 40 is folded in two, an end of a long jig p longer than the stem 40 is touched to a folded part, and the fiber is press-fitted into the stem 40 from an opening at the front end of the stem 40 with the folded part at the head by the jig p.

In the press-fitting, a part on the side of the front end of the inner fiber 60 (a part on the reverse side to the folded part) is left outside and the part on the side of the front end forms the writing part 61 described later.

No coat made of synthetic resin is provided to the outside face of the inner fiber 60.

A part on the front side of the end of the cylindrical tip 43 of the inner fiber 60 partially inserted into the stem 40 as described above is cut along a line c1 shown in FIG. 3(c).

Further, the side of the end of the tip 43 including the inner fiber 60 inside is cut along a line c2 shown in FIG. 3(c) and is adjusted in suitable length.

After cutting, the front end side of the inner fiber 60 is impregnated with a setting agent x made of urethane resin.

At this time, the vicinity of the annular protrusion 43a on the side of the outside face on the front end side of the inner fiber 60 is impregnated with the setting agent x.

As the setting agent x permeates as described above and the front end side of the tip 43 including the inner fiber 60 inside is cut along a line c3 shown in FIG. 3(b) substantially in the shape of a shell after the setting agent x is heated and is hardened, the writing part 61 is exposed.

According to the above-mentioned manufacturing method, the setting agent x permeates a part including the inner fiber fixing cylinder 42b and shown by hatching on the front end side from the inner fiber fixing cylinder 42b. To explain more detailedly, the outside of the writing part 61 is formed so that the density of the setting agent x is high and the outside of the writing part is relatively hard. The central side and the front end side of the writing part 61 are formed so that the density of the setting agent x is low and their sides are relatively soft.

Therefore, as the front end side of the writing part 61 is suitably deformed when the writing part 61 is pressed on a writing object such as paper in writing, not only the thickness of a written line can be easily kept suitable wide but the satisfactory touch of writing can be acquired.

In addition, as the outside face of the writing part 61 is hardened to be relatively hard by the setting agent x, the whole shape of the writing part 61 can be prevented from being collapsed by writing pressure.

According to the above-mentioned configuration, the inner fiber 60 is impregnated with the setting agent x in the vicinity of the annular protrusion 43a on the side of the outside face and is hardened, and further, restoring force that tries to restore the inner fiber to an original condition from a folded condition acts on the inner fiber 60.

Therefore, the annular protrusion 43a and the inner fiber 60 impregnated with the setting agent x and hardened are strongly fitted by the restoring force, and the inner fiber 60 and the writing part 61 can be prevented from being moved in an axial direction by the fitting.

After the writing part 61 is formed as described above, ink M is injected into the stem 40 from an opening at the rear end and permeates the inner fiber 60.

The composition of the ink M is not particularly limited. However, according to the encapsulated fiber type writing instrument equivalent to this embodiment, even if oil based ink having relatively small surface tension is used for ink M, a flow rate of ink can be suitably inhibited by the annular protrusion 43a.

The tail cotter 50 is substantially in the shape of a cylinder with a bottom, a male screw 51 for mating to the female screw 41d on the inside face of the rear end of the stem 40 is formed on an outside face of the front end side of the tail cotter, an annular projection 52 press-fitted to the inside face of the stem 40 for maintaining fluidtightness is formed on the front side of the male screw 51, and the opening at the rear end of the stem 40 is closed by fitting the male screw 51 to the female screw 41b of the stem 40 and press-fitting the annular projection 52 to the press-fitted face 41c of the stem 40.

The tail cotter 50 may also be provided to the stem 40 so that the tail cotter cannot be detached, however, from a viewpoint of enabling the replenishment of ink, it is desirable that the tail cotter is detachably provided to the stem 40 as shown in the drawings.

The cap 70 is a member substantially in the shape of the cylinder with the bottom that wraps the cap fitting part 42, the tip 43 and the writing part 61 respectively on the front end side of the stem 40 and at the bottom, a drying prevention member 71 made of water absorptive material such as urethane foam is inserted to prevent the drying of a front end of the writing instrument 61.

The drying prevention member 71 is fitted to an annular protrusion 72 on the front end side of an inside face of the cap 70 to prevent the drying prevention member from falling backward.

An annular protrusion 73 for fitting the cap over the annular projection 42a of the cap fitting part 42 is formed on the inside face on the rear end side of the cap 70.

Next, the action and the effect of the encapsulated fiber type writing instrument configured as described above will be described in detail.

In a normal downward writing condition, ink M in the inner fiber 60 is guided from the rear end side of the inner fiber 60 to the writing part 61 at the front end of the inner fiber 60 by its own weight and capillary attraction.

At this time, since the distance between fibers on the front end side of the inner fiber 60 is narrowed by local pressure by the annular protrusion 43a, the ink flowing area is also narrowed and a flow rate of ink is suitably inhibited.

The annular protrusion 43a can prevent clearance through which ink flows from being formed between the inside face of the tip 43 and the outside face of the writing part 61.

Therefore, excessive ink can be prevented from flowing from a front end of the writing part 61, ink can be prevented from flowing via the clearance between the outside face of the writing part 61 and the inside face of the tip 43, and particularly even if ink having small surface tension such as oil based ink is used, the action and the effect can be effectively produced.

As the outside face of the writing part 61 is fitted to the annular protrusion 43a on the inside face of the tip 43 in a state hardened by the setting agent x and fitting force is also assisted by the restoring force of the inner fiber that tries to restore the inner fiber to the original condition from the folded condition when pressure by writing force is applied to the writing part 61 and the impact of a drop is applied to the writing part, the writing part 61 can be prevented from being moved in the longitudinal direction by the pressure and the impact of the drop.

The stem 40 of the writing instrument configured as described above can be replaced with a stem 40′ described later.

A helical air flowing groove 41d′ is provided to the stem 40′ in a range touched to the outside face of the inner fiber 60 of an inside face of a body 41 of the stem so as to communicate with the outside of the stem.

That is, the stem 40′ is provided with a pair of substantially helical ribs 41a′ in place of the pair of vertical ribs 41a in the stem 40.

The pair of ribs 41a′ is formed in a substantially helical shape with an axis of the stem body 41 in the center on the inside face of the stem body 41, one rib 41a′ is arranged close to the other rib 41a′, and the air flowing groove 41d′ exists between the pair of ribs 41a′.

The front end side of the air flowing groove 41d′ communicates with air flowing space s described later and air taken in from the outside via the vent 42c flows on the rear side of the stem 40.

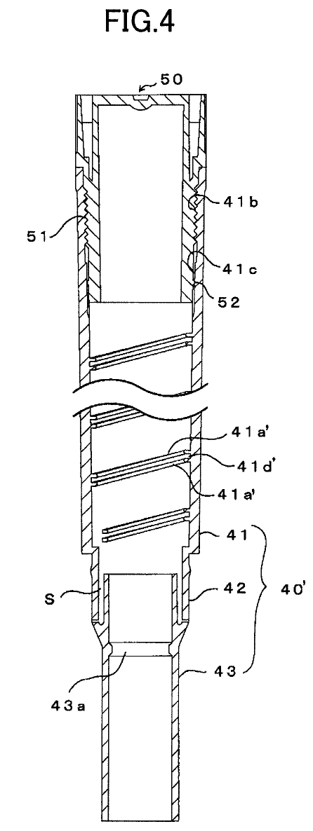

Only a pair of ribs 41a′ are provided in an example shown in FIG. 4, however, plural pairs may also be provided.

According to the stem 40′, as the pair of ribs 41a′ are helical, the outside face of the inner fiber 60 can be effectively prevented from eating into the air flowing groove 41d′ between the pair of ribs 41a′ when the inner fiber 60 is inserted into the stem 40′.

1. An encapsulated fiber type writing instrument using the side of a front end of inner fiber inserted into a stem for a writing part by protruding the side of the front end from a front end of the stem, comprising:
an annular protrusion provided to an inside face on the front end side of the stem for pressing an outside face of the inner fiber; and
an inner fiber fixing cylinder provided to the rear side of the annular protrusion of the stem via annular air flowing space,
wherein a rear end of the air flowing space is open to the inside of the stem;
the air flowing space is extended forward in the stem and its front end is closed; and
the air flowing space communicates with a vent extended in a centrifugal direction of the stem on the way on the side of the front end of the air flowing space.

2. The encapsulated fiber type writing instrument according to claim 1,
wherein the inner fiber is impregnated with a setting agent to harden at least the side of the outside face of the inner fiber in the vicinity of the annular protrusion.

3. The encapsulated fiber type writing instrument according to claim 1,
wherein the inner fiber is encapsulated in the stem with the inner fiber folded in two.

4. The encapsulated fiber type writing instrument according to claim 1, comprising:
a helical air flowing groove provided between a pair of helical ribs formed in a range touched to the outside face of the inner fiber on the inside face of the stem,
wherein the side of a front end of the air flowing groove communicates with the air flowing space.

5. (canceled)

6. (canceled)

7. The encapsulated fiber type writing instrument according to claim 1, comprising:
an air flowing groove provided between a pair of vertical ribs extended in an axial direction of the stem on an inside face on the rear side of the inner fiber fixing cylinder of the stem with the vertical ribs touched to the outside face of the inner fiber,
wherein the side of a front end of the air flowing groove communicates with the air flowing space.

8. The encapsulated fiber type writing instrument according to claim 2,
wherein the inner fiber is encapsulated in the stem with the inner fiber folded in two.
